(19) United States
(12) Patent Application Publication
(10) Pub. No.: US 2013/0205088 A1
(43) Pub. Date: Aug. 8, 2013

(54) MULTI-STAGE CACHE DIRECTORY AND VARIABLE CACHE-LINE SIZE FOR TIERED STORAGE ARCHITECTURES

(71) Applicants: Michael T. Benhase, Tucson, AZ (US); Lokesh M. Gupta, Tucson, AZ (US); Matthew J. Kalos, Tucson, AZ (US)

(72) Inventors: Michael T. Benhase, Tucson, AZ (US); Lokesh M. Gupta, Tucson, AZ (US); Matthew J. Kalos, Tucson, AZ (US)

(73) Assignee: INTERNATIONAL BUSINESS MACHINES CORPORATION, Armonk, NY (US)

(21) Appl. No.: 13/367,155

(22) Filed: Feb. 6, 2012

(51) Int. Cl. G06F 12/08

(52) U.S. Cl. 711/122; 711/E12.024

(57) ABSTRACT

A method in accordance with the invention includes providing first, second, and third storage tiers, wherein the first storage tier acts as a cache for the second storage tier, and the second storage tier acts as a cache for the third storage tier. The first storage tier uses a first cache line size corresponding to an extent size of the second storage tier. The second storage tier uses a second cache line size corresponding to an extent size of the third storage tier. The second cache line size is significantly larger than the first cache line size. The method further maintains, in the first storage tier, a first cache directory indicating which extents from the second storage tier are cached in the first storage tier, and a second cache directory indicating which extents from the third storage tier are cached in the second storage tier.

### BACKGROUND

1. Field of the Invention

This invention relates to systems and methods for caching data, and more particularly to systems and methods for caching data in tiered storage architectures.

1. Background of the Invention

In the field of computing, a “cache” typically refers to a small, fast memory or storage device used to store data or instructions that were accessed recently, are accessed frequently, or are likely to be accessed in the future. Reading from or writing to a cache is typically cheaper (in terms of access time and/or resource utilization) than accessing other memory or storage devices. Once data is stored in cache, it can be accessed in cache instead of re-fetching and/or re-computing the data, saving both time and resources.

Most if not all high-end disk storage systems have internal cache integrated into the system design. For example, the IBM DS8000™ enterprise storage system includes a pair of servers, each of which uses DRAM cache to speed up system performance. When a host device performs a read operation, a server fetches the data from disk arrays and stores the data in the DRAM cache in case it is required again. If the data is requested again by a host device, the server may fetch the data from the DRAM cache instead of fetching it from the disk arrays, saving both time and resources.

In order to manage data in the DRAM cache, the DS8000™ maintains a cache directory in the DRAM cache. This cache directory may be used to determine whether selected data from the disk arrays is in the DRAM cache and, if so, where the data is located in the DRAM cache. In order to accomplish this, the cache directory includes an entry for each extent in the disk arrays, with each entry indicating whether the corresponding extent is cached in the DRAM cache. The size of the cache directory is directly related to the size and thus number of extents in the disk array. For a given disk storage capacity, decreasing the extent size will increase the size of the cache directory, since decreasing the extent size will increase the number of extents and corresponding entries in the cache directory. Similarly, increasing the extent size will decrease the size of the cache directory.

If the cache directory is too large, the cache directory may consume too much of the DRAM cache, thereby reducing the amount of space in the DRAM cache to cache extents from the disk arrays. This may significantly reduce performance. On the other hand, if the extent size is too large (thereby reducing the size of the cache directory), promoting extents between the disk drives and the DRAM cache may be too expensive. As an example, if a host requests a single MB of a 100 MB extent on a disk array, the DS8000™ may need to promote the entire 100 MB extent (the size of the cache line) to the DRAM cache. Thus, the extent size directly affects the effort needed to promote extents between the DRAM cache and the disk arrays.

Thus, a performance tradeoff exists between the size of the cache directory and extent size. To optimize performance, an optimal balance may be determined between the cache directory size and the extent size. That is, an extent size may be selected that provides acceptable data mobility, while providing a cache directory whose size does not unduly hinder the performance of the DRAM cache.

Nevertheless, even if an optimal extent size is selected, increasing the size of the backend storage will still negatively affect the size of the cache directory. That is, as backend storage capacity increases (which is the norm in today's environment), the number of extents increases, thereby increasing the size of the cache directory. This has the negative performance impacts discussed above (i.e., the cache directory consumes too much of the DRAM cache). As backend storage continues to grow (efforts are underway, for example, to virtualize tape storage using disk array storage systems such as the DS8000™), the cache directory will also continue to grow assuming the extent size is kept the same. Although increasing the extent size will decrease the cache directory size, such increases will again undesirably reduce the efficiency of moving data.

In view of the foregoing, what are needed are systems and methods to reduce the negative performance impacts caused by increasing backend storage capacity. Ideally, such systems and methods will provide an extent size that does not unduly limit data mobility, while providing a cache directory size that does not unduly hinder the performance of the DRAM cache.

### SUMMARY

The invention has been developed in response to the present state of the art and, in particular, in response to the problems and needs in the art that have not yet been fully solved by currently available systems and methods. Accordingly, the invention has been developed to provide systems and methods to improve the efficiency of tiered storage architectures. The features and advantages of the invention will become more fully apparent from the following description and appended claims, or may be learned by practice of the invention as set forth hereinafter.

Consistent with the foregoing, a method for implementing a multi-stage cache directory and variable cache-line size in a tiered storage architecture comprising at least three storage tiers is disclosed. In one embodiment, such a method includes providing first, second, and third storage tiers, wherein the first storage tier acts as a cache for the second storage tier, and the second storage tier acts as a cache for the third storage tier. The first storage tier uses a first cache line size corresponding to an extent size of the second storage tier. The second storage tier uses a second cache line size corresponding to an extent size of the third storage tier. The second cache line size is significantly larger than the first cache line size. The method further includes maintaining, in the first storage tier, a first cache directory indicating which extents from the second storage tier are cached in the first storage tier, and a second cache directory indicating which extents from the third storage tier are cached in the second storage tier.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a network environment where a system and method in accordance with the invention may be implemented;

FIG. 2 is a high-level block diagram showing one example of a storage system where a system and method in accordance with the invention may be implemented;

FIG. 3 is a high-level block diagram showing an example of a tiered storage architecture using the same cache-line size for various storage tiers;

FIG. 4 is a high-level block diagram showing an example of a tiered storage architecture in accordance with the invention using a different cache-line size for different storage tiers;

FIG. 5 is a flow chart showing one embodiment of a method for reading and writing data in the tiered storage architecture illustrated in FIG. 4;

FIG. 6 is a high-level block diagram showing an example of a tiered storage architecture, comprising four storage tiers, using a different cache-line size for the various storage tiers; and

FIG. 7 is a flow chart showing one embodiment of a method for reading and writing data in the tiered storage architecture illustrated in FIG. 6.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As will be appreciated by one skilled in the art, the present invention may be embodied as an apparatus, system, method, or computer program product. Furthermore, the present invention may take the form of a hardware embodiment, a software embodiment (including firmware, resident software, micro-code, etc.) configured to operate hardware, or an embodiment combining software and hardware aspects that may all generally be referred to herein as a “module” or “system.” Furthermore, the present invention may take the form of a computer-usable storage medium embodied in any tangible medium of expression having computer-usable program code stored therein.

Any combination of one or more computer-usable or computer-readable storage medium(s) may be utilized to store the computer program product. The computer-usable or computer-readable storage medium may be, for example but not limited to, an electronic, magnetic, optical, electromagnetic, infrared, or semiconductor system, apparatus, or device. More specific examples (a non-exhaustive list) of the computer-readable storage medium may include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CDROM), an optical storage device, or a magnetic storage device. In the context of this document, a computer-usable or computer-readable storage medium may be any medium that can contain, store, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like, and conventional procedural programming languages, such as the “C” programming language or similar programming languages. Computer program code for implementing the invention may also be written in a low-level programming language such as assembly language.

Embodiments of the invention may be described below with reference to flowchart illustrations and/or block diagrams of methods, apparatus, systems, and computer program products. It will be understood that each block of the flowchart illustrations and/or block diagrams, and combinations of blocks in the flowchart illustrations and/or block diagrams, may be implemented by computer program instructions or code. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be stored in a computer-readable storage medium that can direct a computer or other programmable data processing apparatus to function in a particular manner, such that the instructions stored in the computer-readable storage medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

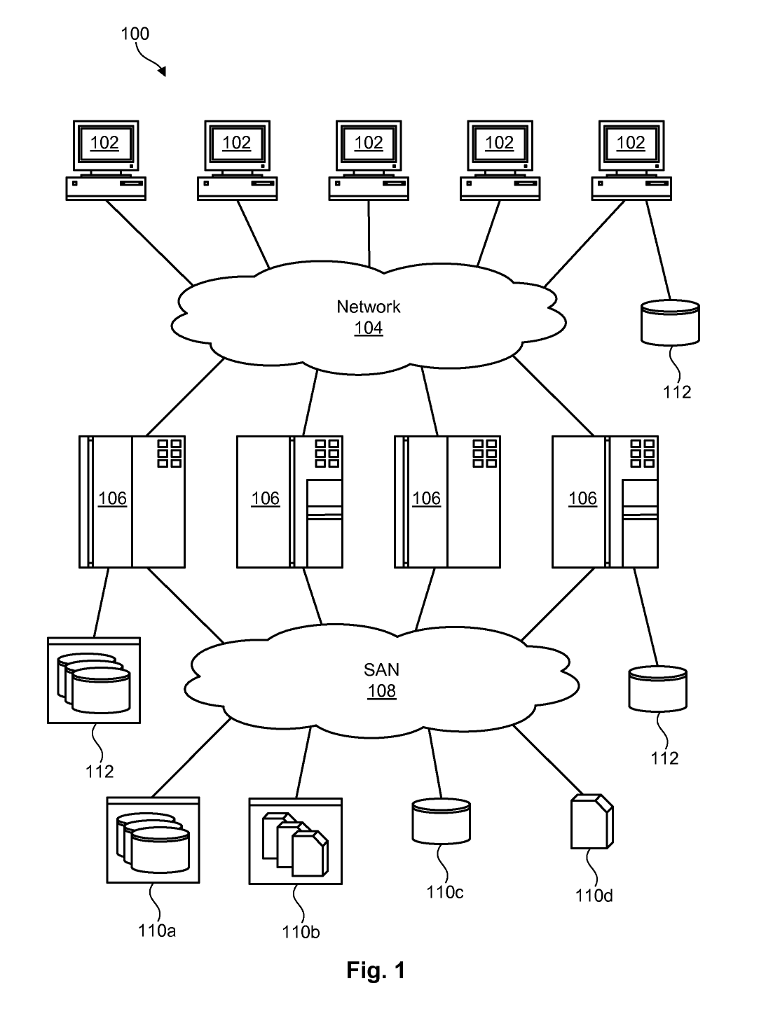

Referring to FIG. 1, one example of a network architecture 100 is illustrated. The network architecture 100 is presented to show one example of an environment where various embodiments of the invention might operate. The network architecture 100 is presented only by way of example and not limitation. Indeed, the systems and methods disclosed herein may be applicable to a wide variety of different network architectures in addition to the network architecture 100 shown.

As shown, the network architecture 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to herein as “hosts” 106 or “host systems” 106). In general, the client computers 102 initiate communication sessions, whereas the server computers 106 wait for requests from the client computers 102. In certain embodiments, the computers 102 and/or servers 106 may connect to one or more internal or external direct-attached storage systems 112 (e.g., arrays of hard-disk drives, solid-state drives, tape drives, etc.). These computers 102, 106 and direct-attached storage systems 112 may communicate using protocols such as ATA, SATA, SCSI, SAS, Fibre Channel, or the like.

The network architecture 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems 110, such as arrays 110a of hard-disk drives or solid-state drives, tape libraries 110b, individual hard-disk drives 110c or solid-state drives 110c, tape drives 110d, CD-ROM libraries, or the like. To access a storage system 110, a host system 106 may communicate over physical connections from one or more ports on the host 106 to one or more ports on the storage system 110. A connection may be through a switch, fabric, direct connection, or the like. In certain embodiments, the servers 106 and storage systems 110 may communicate using a networking standard such as Fibre Channel (FC) or iSCSI.

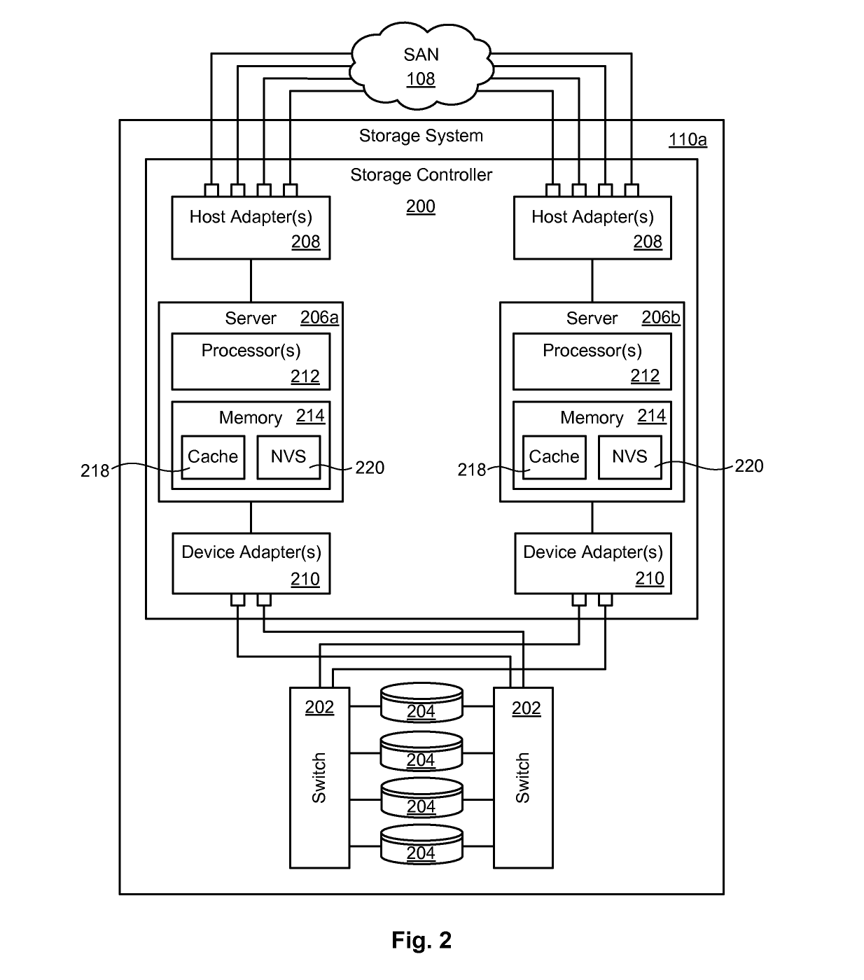

Referring to FIG. 2, one embodiment of a storage system 110a containing an array of storage drives 204 (e.g., hard-disk drives and/or solid-state drives) is illustrated. The internal components of the storage system 110a are shown since the systems and methods disclosed herein may, in certain embodiments, be implemented within such a storage system 110a, although the systems and methods may also be applicable to other storage systems or groups of storage systems. As shown, the storage system 110a includes a storage controller 200, one or more switches 202, and one or more storage drives 204 such as hard disk drives and/or solid-state drives (such as flash-memory-based drives). The storage controller 200 may enable one or more hosts 106 (e.g., open system and/or mainframe servers 106) to access data in the one or more storage drives 204.

In selected embodiments, the storage controller 200 includes one or more servers 206. The storage controller 200 may also include host adapters 208 and device adapters 210 to connect the storage controller 200 to host devices 106 and storage drives 204, respectively. Multiple servers 206a, 206b provide redundancy to ensure that data is always available to connected hosts 106. Thus, when one server 206a fails, the other server 206b may pick up the I/O load of the failed server 206a to ensure that I/O is able to continue between the hosts 106 and the storage drives 203, 204. This process may be referred to as a “failover.”

In selected embodiments, each server 206 may include one or more processors 212 and memory 214. The memory 214 may include volatile memory (e.g., RAM) as well as non-volatile memory (e.g., ROM, EPROM, EEPROM, flash memory, etc.). The volatile and non-volatile memory may, in certain embodiments, store software modules that run on the processor(s) 212 and are used to access data in the storage drives 204. The servers 206 may host at least one instance of these software modules. These software modules may manage all read and write requests to logical volumes in the storage drives 204.

In selected embodiments, the memory 214 includes a cache 218, such as a DRAM cache 218. Whenever a host 106 (e.g., an open system or mainframe server 106) performs a read operation, the server 206 that performs the read may fetch data from the storages drives 204 and save it in its cache 218 in the event it is required again. If the data is requested again by a host 106, the server 206 may fetch the data from the cache 218 instead of fetching it from the storage drives 204, saving both time and resources. Similarly, when a host 106 performs a write, the server 106 that receives the write request may store the write in its cache 218, and destage the write to the storage drives 204 at a later time. When a write is stored in cache 218, the write may also be stored in non-volatile storage (NVS) 220 of the opposite server 206 so that the write can be recovered by the opposite server 206 in the event the first server 206 fails.

One example of a storage system 110a having an architecture similar to that illustrated in FIG. 2 is the IBM DS8000™ enterprise storage system. The DS8000™ is a high-performance, high-capacity storage controller providing disk and solid-state storage that is designed to support continuous operations. Nevertheless, the methods disclosed herein are not limited to the IBM DS8000™ enterprise storage system 110a, but may be implemented in any comparable or analogous storage system or group of storage systems, regardless of the manufacturer, product name, or components or component names associated with the system. Any storage system that could benefit from one or more embodiments of the invention is deemed to fall within the scope of the invention. Thus, the IBM DS8000™ is presented only by way of example and is not intended to be limiting.

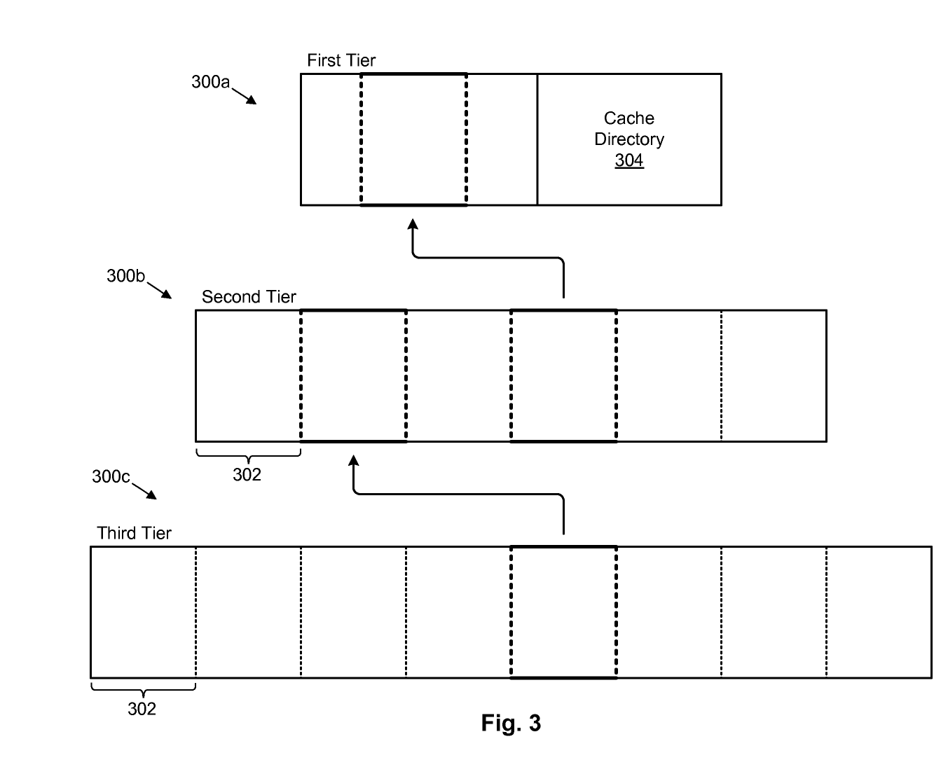

Referring to FIG. 3, in certain embodiments, a storage system 110a such as that illustrated in FIG. 2 may be configured with different storage tiers 300. Each of the storage tiers 300 may contain different types of storage media having different performance and/or cost. Higher cost storage media is generally faster while lower cost storage media is generally slower. Because of its reduced cost, the tiered storage architecture may include substantially more storage capacity for lower cost storage media than higher cost storage media. Storage management software and/or firmware running on a host device 106 or the storage system 110a may automatically move data between high cost and low cost storage media to optimize performance. For example, hotter data (i.e., data that is accessed frequently) may be promoted to faster storage media while colder data (i.e., data that is accessed infrequently) may be demoted to slower storage media. As the hotness and coldness of data changes, the data may be moved between the storage tiers.

The storage media used to implement the different storage tiers 300 may vary. In one example, the first storage tier 300a is made up of high-speed memory, such as the DRAM cache 218 previously mentioned, the second storage tier 300b is made up of solid-state drives, and the third storage tier 300c is made up of hard-disk drives. In this example, due to the cost of the storage media, the second storage tier 300b has more storage capacity than the first storage tier 300a, and the third storage tier 300c has more storage capacity than the second storage tier 300b.

In tiered storage architectures, data may be moved between storage tiers in equal-sized partitions or allocations, called “extents.” In conventional tiered storage architectures, the extent size is typically consistent across the different storage tiers 300a, 300b, 300c. In one example, the total address space of the storage tiers 300b, 300c, is divided into 1 GB extents. The 1GB extents may then be moved between the storage tiers 300 as the hotness or coldness of the data contained therein changes.

In order to manage data in the first storage tier 300a (e.g., a DRAM cache 218), a cache directory 304 may be maintained in the first storage tier 300a. This cache directory 304 may be used to determine whether selected data from the other storage tiers 300b, 300c is in the first storage tier 300a and, if so, where the data is located in the first storage tier 300a. In order to accomplish this, the cache directory 304 may include an entry for each extent 302 in the second and third storage tiers 300b, 300c. Thus, the size of the cache directory 304 (which is a function of the number of entries in the cache directory 304) is directly related to the size of extents 302 in the storage tiers 300b, 300c. Increasing the number of extents 302 in the storage tiers 300b, 300c also increases the number of locations the cache directory 304 must be able to address. This increases the number of address bits needed in each cache directory entry to address the extents 302. This further increases the size of the cache directory 304.

As previously mentioned, for a given disk storage capacity, decreasing the extent size will increase size of the cache directory 304. Similarly, increasing the extent size will decrease the size of the cache directory 304. If the cache directory 304 is too large, the cache directory 304 may consume too much of the first storage tier 300a (e.g., the DRAM cache 218), thereby reducing the amount of space in the first storage tier 300a that is dedicated to caching extents 302 from the second and third storage tiers 300b, 300c. This may significantly reduce the performance of the first storage tier 300a. On the other hand, if the extent size is too large (thereby reducing the size of the cache directory 304), moving extents 304 between the storage tiers 300a, 300b, 300c may be too extensive. For example, using a 1 GB extent size, if a host 106 requests 10 MB of the 1 GB extent 302, the entire 1 GB extent may need to be allocated in the first storage tier 300a.

Thus, a performance tradeoff exists between the size of the cache directory 304 and extent size. To optimize performance, an optimal balance may be determined between the cache directory size and the extent size. That is, an extent size may be selected that provides acceptable data mobility, while providing a cache directory size that does not unduly hinder performance.

Nevertheless, even if an optimal extent size is selected, increasing the size of the backend storage will still negatively affect the size of the cache directory 304. That is, as backend storage capacity increases (which is the norm in today's environment), the number of extents 302 increases, thereby increasing the size of the cache directory 304. This has the negative performance impacts discussed above (i.e., the cache directory 304 consumes too much of the first tier 300a). As backend storage continues to grow (efforts are underway, for example, to virtualize tape storage using disk array storage systems such as the DS8000™) the cache directory 304 will continue to grow assuming the extent size is kept the same. Although increasing the extent size may be used to decrease the cache directory size, such increases will again undesirably reduce the efficiency of moving data.

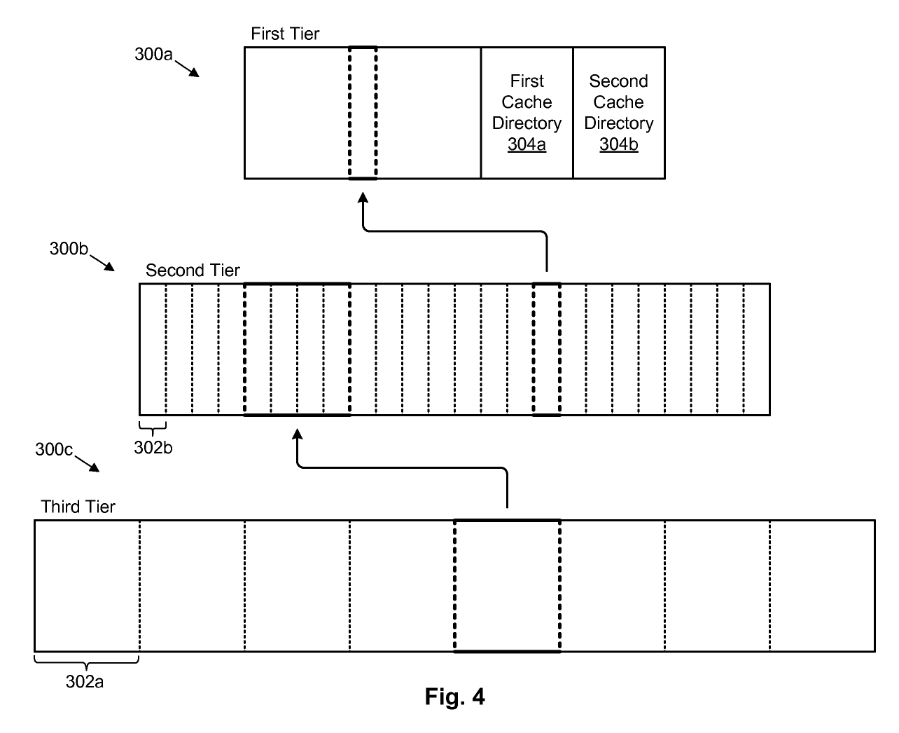

Thus, systems and methods are needed to reduce the negative performance impacts caused by increasing the amount of backend storage capacity. Ideally, such systems and methods will provide an extent size that provides acceptable data mobility, while providing a cache directory size that does not unduly hinder performance. One embodiment of such a system and method will be described in association with FIG. 4.

Referring to FIG. 4, in certain embodiments in accordance with the invention, different cache line sizes may be used by the first and second storage tiers 300a, 300b to reduce the size of the cache directory 304 while also providing acceptable data mobility. As shown in the illustrated embodiment, the first storage tier 300a uses a first cache line size corresponding to a first extent size 302b used by the second storage tier 300b. Similarly, the second storage tier 300b uses a second cache line size corresponding to a second extent size 302a used by the third storage tier 300c. As shown, the extent size 302a used by the third storage tier 300c is significantly larger than the extent size 302b used by the second storage tier 300b. As a result, larger extents 302a are promoted from the third storage tier 300c to the second storage tier 300b, and comparatively smaller extents 302b are promoted from the second storage tier 300b to the first storage tier 300a.

To accommodate the different extent sizes of the second and third storage tiers 300b, 300c, a multi-stage cache directory 304 may be stored and maintained in the first storage tier 300a. In this example, the multi-stage cache directory 304 includes a first cache directory 304a, which indicates which extents from the second storage tier 300b are cached in the first storage tier 300a, and a second cache directory 304b, which indicates which extents from the third storage tier 300c are cached in the second storage tier 300b. The first cache directory 304a only needs to have addressability for extents 302b in the second storage tier 300b. Similarly, the second cache directory 304b only needs to have addressability for extents 302a in the third storage tier 300c. Because the address space of the second storage tier 300b (which includes faster and more expensive storage media than the third storage tier 300c) is smaller than that of the third storage tier 300c, the granularity (i.e., size) of extents 302b of the second storage tier 300b may be much finer than those of the third storage tier 300c.

The above-described technique allows the multi-stage cache directory 304 (which includes both the first cache directory 304a and the second cache directory 304b) to be kept a reasonable size even when the size of the backend storage (e.g., the third storage tier 300c) is increased. That is, the larger extent size 302a of the backend storage reduces the number of entries in (and thus the size of) the second cache directory 304b. The smaller extents 302b in the second storage tier 300b, on the other hand, improve data mobility. Hotter data (i.e., more frequently accessed data) will typically reside in higher levels of the tiered storage architecture (e.g., the first and second storage tiers 300a, 300b) and thus will tend to be promoted and demoted more frequently. The smaller extent size 302b of the second storage tier 300b will tend to facilitate this movement between the first and second storage tiers 300a, 300b.

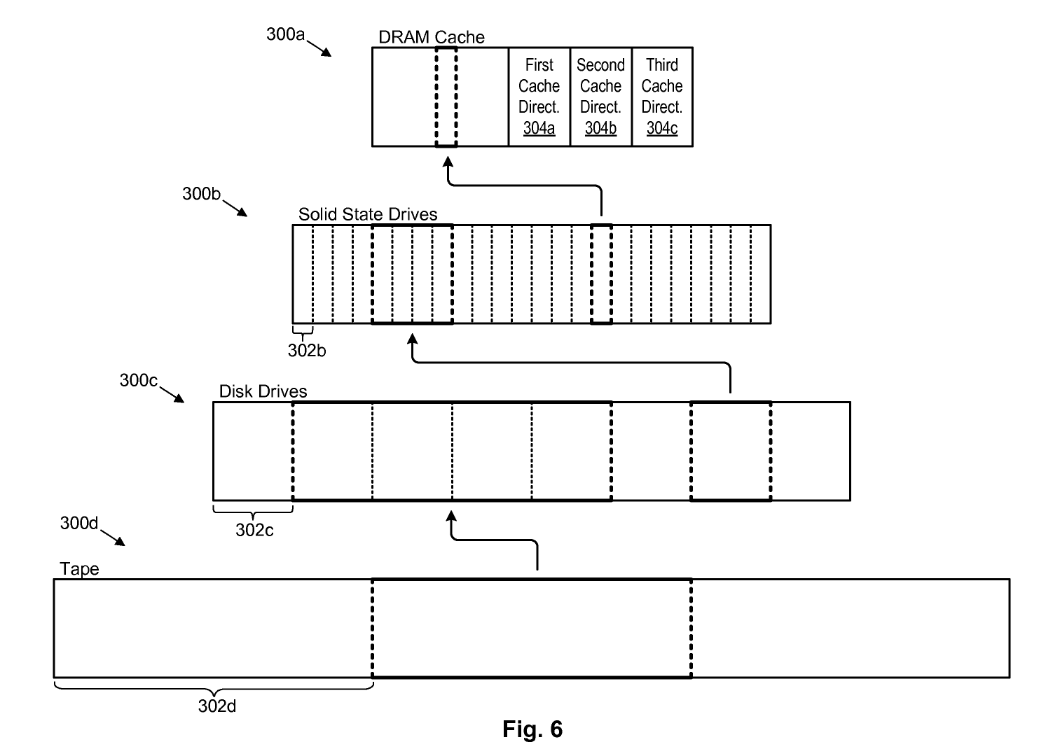

It should be recognized that the techniques discussed above in association with FIG. 4 may be easily expanded to include additional storage tiers 300 and cache directory stages 304. Thus, the example provided in FIG. 4 is presented only by way of example and not limitation. Embodiments of the invention are applicable to tiered storage architectures comprising three or more storage tiers 300. A specific example of a tiered storage architecture comprising four storage tiers will be discussed in association with FIG. 6.

It should also be recognized that the relative sizes of the illustrated extents 302a, 302b are provided only by way of example and not limitation. For example, in FIG. 4, the extent 302b is shown to be one fourth of the size of the extent 302a. This ratio is used only for illustration purposes and is not intended to reflect the ratios that may be used in real-world applications. Indeed, the ratio is likely to be much greater in real-world applications, although this is not necessarily the case. In general, any tiered storage architecture where the extent size for faster and more expensive storage media is smaller than the extent size for slower and less expensive storage media is deemed to fall within the scope of the invention.

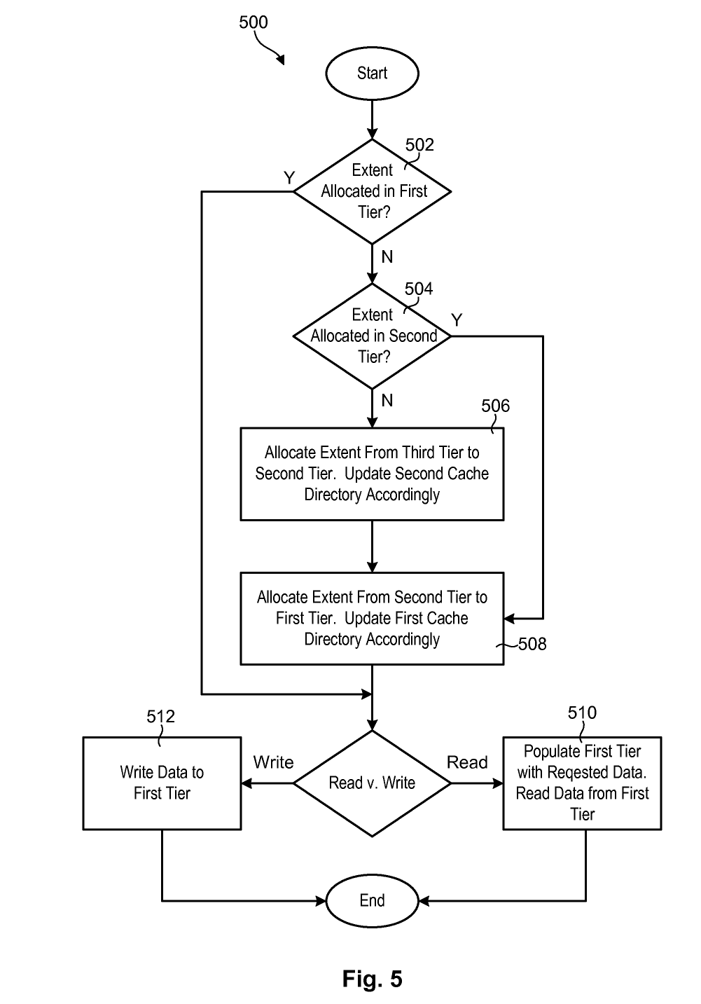

Referring to FIG. 5, one embodiment of a method 500 for reading or writing data in a tiered storage architecture (such as that described in FIG. 4) is illustrated. The method 500 assumes that the tiered storage architecture is “inclusive,” meaning that any extent contained in a higher tier is also contained in a lower tier. For example, the method 500 assumes that any extent contained in the first storage tier 300a is also contained in the second storage tier 300b, and that any extent contained in the second storage tier 300b is also contained in the third storage tier 300c.

As shown, when an I/O request is received, the method 500 determines 502 whether the extent that is being read from or written to is allocated in the first storage tier 300a. This may be accomplished by examining the first cache directory 304a. If the extent is in the first storage tier 300a, the method 500 populates 510 the extent with the requested data if needed and reads 510 the data in the first storage tier 300a (in the case of a read) or writes 512 the data to the first storage tier (in the case of a write) and the method 500 ends.

If the extent that is being read from or written to is not in the first storage tier 300a, the method 500 determines 504 whether the extent is in the second storage tier 300b. This may be accomplished by examining the second cache directory 304b. If the extent is in the second storage tier 300b, the method 500 allocates 508 the extent containing the data from the second storage tier 300b to the first storage tier 300a. This includes updating 508 the first cache directory 304a to indicate that the extent has been promoted to the first storage tier 300a. The method 500 then populates 510 the extent with the requested data and reads 510 the data in the first storage tier 300a (in the case of a read) or writes 512 the data to the first storage tier (in the case of a write) and the method 500 ends.

If the extent that is being read from or written to is not in the second storage tier 300b, the method 500 assumes that the extent is in the third storage tier 300c. In such a case, the method 500 allocates 506 the extent from the third storage tier 300c to the second storage tier 300b and updates 506 the second cache directory 304b accordingly. The method 500 then allocates 508 the extent from the second storage tier 300b to the first storage tier 300a and updates 508 the first cache directory 304a accordingly. The method 500 then populates 510 the extent with the requested data and reads 510 the data in the first storage tier 300a (in the case of a read) or writes 512 the data to the first storage tier (in the case of a write) and the method 500 ends. In this way, an extent is promoted up the tiered storage hierarchy in response to an I/O request.

It should be recognized that promoting an extent from a lower storage tier 300 to a higher storage tier 300 does not necessarily include copying all data in the extent to the higher storage tier. Rather, promoting an extent from a lower storage tier 300 to a higher storage tier 300 may simply include allocating address space for the extent in the higher storage tier 300. In certain embodiments, only the requested data or some subset of the data in the extent is copied to a higher storage tier when the extent containing the data is promoted to a higher storage tier. In other embodiments, most or all of the data in the extent is copied to the higher storage tier when the extent is promoted to the higher storage tier, although this may reduce performance.

Writing data to the tiered storage architecture may be similar to reading data from the tiered storage architecture except that the data propagates down the tiered storage architecture instead of up the tiered storage architecture. That is, when data is written to the first storage tier 300a, the data is copied to appropriate extents in the second and third storage tiers 300b, 300c. This satisfies the rule that any data contained in a higher storage tier is also contained in a lower storage tier. Eventually, the data in the first storage tier 300a may be evicted or demoted from the first storage tier 300a as the data ages or becomes cold, leaving the data in lower storage tiers.

Referring to FIG. 6, one example of a tiered storage architecture comprising four storage tiers is illustrated. In this example, the first storage tier 300a comprises DRAM cache, the second storage tier 300b comprises solid state drives, the third storage tier 300c comprises disk drives, and a fourth storage tier 300d comprises magnetic tape. In the illustrated embodiment, the DRAM cache 300a uses a first cache line size corresponding to an extent size 302b used in the sold state drives 300b, the solid state drives 300b use a second cache line size corresponding to an extent size 302c used by the disk drives 300c, and the disk drives 300c use a third cache line size corresponding to an extent size 302d used on the magnetic tape.

As shown, the extent size 302d used by the magnetic tape 300d is larger than the extent size 302c used by the disk drives 300c, which is in turn larger than the extent size 302b used by the solid state drives 300b. Thus, the largest extents 302d are promoted from the magnetic tape 300d to the disk drives 300c, the next largest extents 302c are promoted from the disk drives 300c to the solid state drives 300b, and the smallest extents 302b are promoted from the solid state drives 300b to the DRAM cache 300a. In this example, the multi-stage cache directory 304 includes a first cache directory 304a, which indicates which extents from the solid state drives 300b are cached in the DRAM cache 300a, a second cache directory 304b, which indicates which extents from the disk drives 300c are cached in the solid state drives 300b, and a third cache directory 304c which indicates which extents from the magnetic tape 300d are cached in the disk drives 300c.

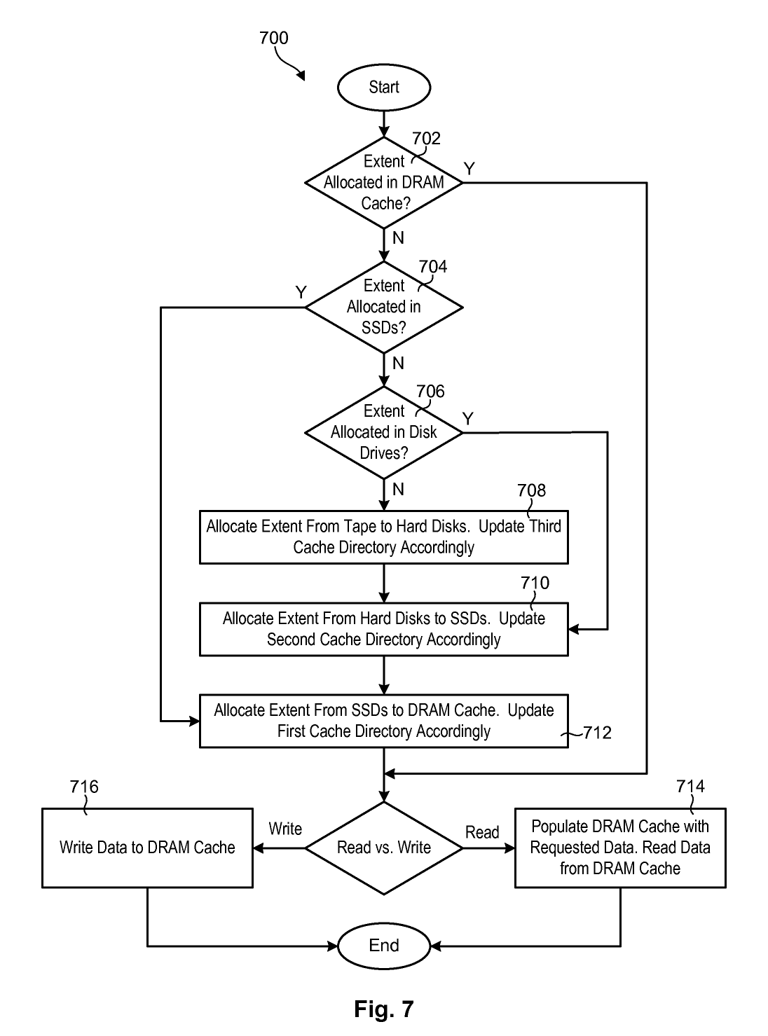

Referring to FIG. 7, one embodiment of a method 700 for reading or writing data in a tiered storage architecture such as that described in association with FIG. 6 is illustrated. Like the method 500 of FIG. 5, the method 700 assumes that the tiered storage architecture is “inclusive.” As shown, when an I/O request is received, the method 700 initially determines 702 whether the extent being read from or written to is in the DRAM cache 300a. If the extent is in the DRAM cache 300a, the method 700 populates 714 the extent with the requested data if needed and reads 714 the data (in the case of a read) or writes 716 data to the extent (in the case of a write) and the method 700 ends.

If the extent being read from or written to is not in the DRAM cache 300a, the method 700 determines 704 whether the extent is in the solid state drives 300b. If the extent is in the solid state drives 300b, the method 700 allocates 712 the extent from the solid state drives 300b to the DRAM cache 300a and updates 712 the first cache directory 304a to indicate that the extent has been promoted to the DRAM cache 300a. The method 700 then populates 714 the extent with the requested data and reads 714 the data (in the case of a read) or writes 716 data to the extent (in the case of a write) and the method 700 ends.

If the extent being read from or written to is not in the solid state drives 300b, the method 700 determines 706 whether the extent is in the disk drives 300c. If the extent is in the disk drives 300c, the method 700 allocates 710 the extent from the disk drives 300c to the solid state drives 300b and updates 710 the second cache directory 304b to indicate that the extent has been promoted to the solid state drives 300b. The method 700 then allocates 712 the extent from the solid state drives 300b to the DRAM cache 300a and updates 712 the first cache directory 304a accordingly. The method 700 then populates 714 the extent with the requested data and reads 714 the data (in the case of a read) or writes 716 data to the extent (in the case of a write) and the method 700 ends.

If the extent being read from or written to is not in the disk drives 300c, the method 700 assumes that the extent is on the magnetic tape 300d. In such a case, the method 700 allocates 708 the extent from the magnetic tape 300d to the disk drives 300c and updates 708 the third cache directory 304c accordingly. The method 700 then allocates 710 the extent from the disk drives 300c to the solid state drives 300b and updates 710 the second cache directory 304b accordingly. The method 700 then allocates 712 the extent from the solid state drives 300b to the DRAM cache 300a and updates 712 the first cache directory 304a accordingly. The method 700 then populates 714 the extent with the requested data and reads 714 the data (in the case of a read) or writes 716 data to the extent (in the case of a write) and the method 700 ends.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1-7. (canceled)

8. A computer program product for improving the efficiency of a tiered storage architecture comprising at least three storage tiers, the computer program product comprising a non-transitory computer-readable storage medium having computer-usable program code embodied therein, the computer-usable program code comprising:
computer-usable program code to manage first, second, and third storage tiers, wherein the first storage tier acts as a cache for the second storage tier, and the second storage tier acts as a cache for the third storage tier;
computer-usable program code to use, in the first storage tier, a first cache line size corresponding to an extent size of the second storage tier;
computer-usable program code to use, in the second storage tier, a second cache line size corresponding to an extent size of the third storage tier, wherein the second cache line size is significantly larger than the first cache line size;
computer-usable program code to maintain, in the first storage tier, a first cache directory indicating which extents from the second storage tier are cached in the first storage tier; and
computer-usable program code to maintain, in the first storage tier, a second cache directory indicating which extents from the third storage tier are cached in the second storage tier.

9. The computer program product of claim 8, wherein the third storage tier has significantly more storage capacity than the second storage tier, and the second storage tier has significantly more storage capacity than the first storage tier.

10. The computer program product of claim 8, wherein the third storage tier comprises slower storage media than the second storage tier, and the second storage tier comprises slower storage media than the first storage tier.

11. The computer program product of claim 8, further comprising computer-usable program code to locate an extent in the tiered storage architecture by analyzing the first cache directory to determine if the extent is cached in the first storage tier and, if the extent is not cached in the first storage tier, analyzing the second cache directory to determine if the extent is cached in the second storage tier.

12. The computer program product of claim 11, further comprising computer-usable program code to, if the extent is not cached in the second storage tier, promote the extent from the third storage tier to the second storage tier.

13. The computer program product of claim 11, further comprising computer-usable program code to, if the extent is cached in the second storage tier but is not cached in the first storage tier, promote the extent from the second storage tier to the first storage tier.

14. The computer program product of claim 8, further comprising computer-usable program code to ensure that any extent that is cached in the first storage tier is also cached in the second storage tier.

15. A system comprising:
first, second, and third storage tiers, wherein the first storage tier acts as a cache for the second storage tier, and the second storage tier acts as a cache for the third storage tier, wherein the first, second, and third storage tiers are configured as follows:
the first storage tier uses a first cache line size corresponding to an extent size of the second storage tier;
the second storage tier uses a second cache line size corresponding to an extent size of the third storage tier, wherein the second cache line size is significantly larger than the first cache line size; and
the first storage tier stores a first cache directory indicating which extents from the second storage tier are cached in the first storage tier, and a second cache directory indicating which extents from the third storage tier are cached in the second storage tier.

16. The system of claim 15, wherein the third storage tier has significantly more storage capacity than the second storage tier, and the second storage tier has significantly more storage capacity than the first storage tier.

17. The system of claim 15, wherein the third storage tier comprises slower storage media than the second storage tier, and the second storage tier comprises slower storage media than the first storage tier.

18. The system of claim 15, wherein any extent that is cached in the first storage tier is also cached in the second storage tier.
